(19) United States
(12) Patent Application Publication
(10) Pub. No.: US 2023/0258162 A1
(43) Pub. Date: Aug. 17, 2023

(54) MEASURING DEVICE FOR WIND TURBINES

(71) Applicant: eologix sensor technology gmbh, Graz (AT)

(72) Inventors: Michael MOSER, Graz (AT); Theresa LOSS, Graz (AT)

(73) Assignee: eologix sensor technology gmbh, Graz (AT)

(21) Appl. No.: 18/020,534

(22) PCT Filed: Aug. 12, 2021
(86) PCT No.: PCT/AT2021/060282

§ 371 Date: Feb. 9, 2023

(30) Foreign Application Priority Data
Aug. 14, 2020 (AT) A 50683/2020

(51) Int. Cl. F03D 17/00; G01M 5/00; G01P 15/18; G01P 1/00

(52) U.S. Cl. CPC F03D 17/00; G01M 5/00; G01P 15/18; G01P 1/00; F05B 2270/807

(57) ABSTRACT

A measuring arrangement for detecting deformations, in particular bending of the outer surface, of a wind turbine structural element, includes: at least two measurement sites on the structural element spaced apart from one another toward a structural element extension, each having at least one acceleration sensor, that can be communication-connected—preferably via a wireless interface—to an evaluation device. The measuring arrangement—has at least two speed sensors, in particular angular speed sensors, on the structural element and spaced apart from one another toward a structural element extension, preferably the longitudinal extension, and/or the measuring arrangement has at least two position sensors, in particular magnetic field sensors, on the structural element and spaced apart from one another toward a structural element extension, preferably the longitudinal extension. The speed sensors and/or the position sensors can be communication-connected to the evaluation device—preferably via a wireless interface.

The invention relates to a measuring arrangement for detecting deformations, in particular bending of the outer surface, of a structural element of a wind turbine, comprising at least two measurement sites arranged on the structural element, that are spaced from one another in the direction of an extension, preferably the longitudinal extension, of the structural element and each having at least one acceleration sensor, wherein the acceleration sensors can be communication-connected—preferably via a wireless interface—to an evaluation device. The invention also relates to a wind turbine according to the preamble of claim 19 and a method for operating a wind turbine according to the preamble of claim 22.

DE 10 2018 119733 A1 discloses a method for monitoring torsion and/or monitoring pitch of a rotor blade of a wind energy plant. In this process, a first acceleration is measured in at least two first dimensions at a first position of the rotor blade, and a second acceleration is measured in at least two second dimensions at a second position of the rotor blade radially spaced apart from the first position. Determining a torsion and/or a pitch angle of the rotor blade takes place on the basis of first acceleration proportions in the two first dimensions of the first acceleration and on the basis of second acceleration proportions in the two second dimensions of the second acceleration. With such a method, no further deformations—beyond torsion—can be identified. Additionally, the accuracy of the torsion identification is insufficient and is strongly dependent on the knowledge of the exact position of the acceleration sensors. How-ever, said position is often not known exactly due to production tolerances, aging effects and/or permanent deformations of the rotor blade, so that unknowable errors may occur in the identification of the torsion.

DE 10 2010 032120 A1 discloses a method for determining a bending angle of a rotor blade of a wind turbine. In this process, an acceleration signal representing an acceleration acting on the rotor blade essentially perpendicular to the rotor plane is determined and the bending angle is determined using the acceleration signal. One embodiment uses information on a distance of an acceleration sensor providing the acceleration signal from a rotor axis, an inclination angle of the rotor axis with respect to the horizontal line and/or an acceleration of a tower head of the wind turbine as well as information on the rotation speed and rotational position of the rotor in the determination of the bending angle. However, it has been shown that the mere knowledge of the rotation speed and the rotational position of the rotor does not sufficiently increase the accuracy of the identification of deformations.

The object of the present invention was to overcome the shortcomings of the prior art and to provide a wind turbine measuring arrangement, by means of which deformations of a structural element of a wind turbine can be detected with high accuracy.

This object is achieved by a measuring arrangement of the initially mentioned type in that the measuring arrangement has at least two speed sensors, in particular angular speed sensors, arranged on the structural element and spaced apart from one another in the direction of an extension, preferably the longitudinal extension, of the structural element, and/or that the measuring arrangement has at least two position sensors, in particular magnetic field sensors, arranged on the structural element and spaced apart from one another in the direction of an extension, preferably the longitudinal extension, of the structural element, wherein the speed sensors and/or the position sensors can be communication-connected to the evaluation device—preferably via a wireless interface.

According to the invention, the sensors provided in addition to the acceleration sensors—i.e. the speed sensors and/or position sensors—are arranged on the structural element (the defor-mation of which is to be detected) itself. This way, in addition to the acceleration data at two different locations of the structural element, additional information, namely speed and/or position data, is also obtained at two different locations of the structural element. A reliable and significantly more precise detection of the deformations of the structural element can be ensured by means of a link between the acceleration data and the speed and/or position data,. The reason for this lies in that the measurement sites themselves vary in their speed and/or po- sition—depending on the deformation of the structural element. Thus, additional information on the current state of deformation can be obtained using these additionally arranged sensors—on the structural element itself.

The deformations detected using the measuring arrangement according to the invention may be both elastic and plastic deformations. Likewise, the detected deformations may be short-term, periodic, aperiodic deformations, or deformations developing over a longer period of time (for example caused by aging effects). Distinguished by type, the detected deformations may in particular be bending of the entire structural element, bending of the outer surface, oscillations, vibrations, torsions and/or deviations from an initial and/or known normal state.

The deformations may be identified depending on different parameters, for example as a function of time, the rotor angle, the temperature, or other weather conditions, the wind force, the wind direction, etc. However, the deformations may also be detected in their type, their temporal course (e.g. frequency, transient and/or decay characteristic), and their intensity (amplitude).

It is preferred if the measuring arrangement comprises at least two acceleration sensors and at least two speed sensors. Alternatively or additionally, at least two position sensors may be provided on the structural element.

Sensors based on the piezoelectric effect may be used as acceleration sensors. In this regard, oftentimes, the force resulting from the acceleration is transferred, via a ground, to a piezoelectric material, the compression and/or elongation of which can be detected electronically. Of course, it is also possible to use optical, in particular fiber-optical acceleration sensors. Mechanical systems in which a ground acts on, e.g., an elongation measuring device (e.g. strain gauges) are also conceivable. The acceleration sensors are preferably embodied as micro-electro-mechanical systems (MEMS).

The speed sensors may be, e.g. angular speed sensors or gyroscopes, preferably also in a MEMS embodiment.

Position sensors serve to determine the absolute and/or relative position and/or orientation of the measurement site. Here, (terrestrial) magnetic field sensors are preferably used as they allow for an orientation relative to the always existent terrestrial magnetic field. This is interesting particularly in a use of the measuring arrangement on one or multiple rotor blades, as a relative position or orientation relative to a fixed structure, such as e.g., the tower of the wind turbine, can be determined, in particular the current rotation angle of the (measurement) site, at which the position sensor is arranged. Alternatively or additionally, optical sensors or GPS sensors would also be conceivable as position sensors.

The sensors of the measuring arrangement are communication-connectable and/or communication-connected—either wired or via a wireless interface—to an evaluation device. This connectivity may be characterized by a constant and/or continuous data transfer or by request signal of the evaluation device or regular data signals on the sensor side.

A great advantage of the invention consists in that due to the additional sensors—speed sensors and/or position sensors—the current positions of the (measurement) sites at which the sensors are arranged can be determined with high accuracy. Positional changes of the measurement sites can be detected within the millimeter range, whereby a very precise detection of the deformations may also take place—based on the positions and/or positional changes of the measurement sites. The more measurement sites are provided, the more precisely the type and profile of a deformation can be determined.

A preferred embodiment is characterized in that the distance between adjacent measurement sites is at least 1 m, preferably at least 5 m, and/or that the distance between adjacent measurement sites is a maximum of 20 m, preferably a maximum of 10 m. These distances are preferred distances, particularly with respect to individual rotor blades, the length of which falls in the range of multiples of 10 m (e.g. 50 m). Generally, the following embodiment, which is based on relative specifications, and which is also preferably applicable to longer structural elements (tower) and shorter structural elements (nacelle) has proven itself.

Such a preferred embodiment is characterized in that the distance between adjacent measurement sites amounts to at least 2%, preferably at least 5%, of the longitudinal extension, i.e. the total length, of the structural element (to be monitored) and/or that the distance between adjacent measurement sites amounts to a maximum of 40%, preferably a maximum of 20%, particularly preferred to be a maximum of 10%, of the longitudinal extension of the structural element (to be monitored).

A preferred embodiment is characterized in that the structural element is a rotor blade or the nacelle or the tower or the foundation of a wind turbine. These structural elements are subjected to particularly strong deformations. The knowledge of them does not only allow optimal controlling of the wind turbine but also allows to draw conclusions on damage, age-related signs (of wear), particular weather conditions (e.g. ice formation on the structural elements), etc.

A preferred embodiment is characterized in that the at least two speed sensors and/or the at least two position sensors are arranged on the structural element such that the at least two measurement sites, which both have at least one acceleration sensor each, additionally have at least one speed sensor and/or at least one position sensor each. In other words: The speed sensor and/or position sensors are each arranged at the same positions as the acceleration sensors, i.e. the measurement sites each comprise at least one acceleration sensor and at least one speed sensor and/or position sensor. The expression “the same position” naturally comprises the possibility that the sensors belonging to a measurement site may also be arranged next to one another or on top of one another and may also have a small distance between one another. However, such a distance is much smaller in comparison to the extension of the structural element. A particularly preferred embodiment consists in that the measurement sites each have at least three sensors, namely an acceleration sensor, an (angular) speed sensor, and a position sensor. As a result, information can be received in all temporal dimensions.

A preferred embodiment is characterized in that the measuring arrangement comprises at least three, preferably at least five, measurement sites arranged on the structural element, which measurement sites are spaced apart from one another in the direction of the longitudinal extension of the structural element and each having at least one acceleration sensor, wherein the measurement sites preferably each have at least one speed sensor and/or at least one position sensor—in addition to the acceleration sensor. By providing multiple measurement sites spaced apart from one another, particularly a precise bending profile, e.g. along the tower or along the longitudinal extension of the rotor blade, can be determined, whereby deformation states or profiles which are similar yet different in their type (and e.g. result from different causes) can be distinguished reliably.

A preferred embodiment is characterized in that the distance between an acceleration sensor and a speed sensor and/or position sensor belonging to the same measurement site amounts to a maximum of 5 cm, preferably a maximum of 5 mm This allows defining the position of the measurement sites and determining it from the sensor data particularly precisely. In further consequence, the deformations of the structural element can be determined precisely from the position data of multiple measurement sites and even the bending profile can be identified.

A preferred embodiment is characterized in that the structural element is a rotor, and at least one, preferably at least two, of the measurement sites is/are arranged in the region of the rotor blade tip and/or at a distance from the rotor blade tip, which distance is at the most as great as 50%, preferably at most as great as 20%, of the total length of the rotor blade. By means of the arrangement of the measurement sites in the outer half of the rotor blade, important information on those sites of the rotor blade, which are subjected to particularly strong accelerations and positional changes, is received.

A preferred embodiment is characterized in that at least one measurement site is arranged away from the connecting line between the outermost measurement sites of the measuring arrangement, preferably between the measurement site closest to the rotor blade root and the measurement site closest to the rotor blade tip, wherein the normal distance from the connecting line preferably amounts to at least 20 cm, preferably at least 50 cm. These normal distances are preferred distances, particularly with respect to individual rotor blades, the length of which falls in the range of multiples of 10 m (e.g. 50 m). Generally, the following embodiment, which is based on relative specifications, and which is also preferably applicable to longer and/or larger structural elements (tower) and shorter and/or smaller structural elements (nacelle) has proven itself.

Such a preferred embodiment is characterized in that said normal distance from the connecting line is at least 0.5%, preferably at least 1%, of the longitudinal extension, i.e. of the total length, of the normal distance (to be monitored).

An embodiment is characterized in that at least one measurement site is arranged on a first side, in particular the front side, of the structural element, and at least one measurement site is arranged on a second side opposite the first side, in particular on the rear side, of the structural element.

By means of the last three embodiments, not only the bending profiles along a longitudinal extension can be detected, but also complex three-dimensional deformations, including torsions, and three-dimensional vibrational modes can be detected and recognized as such.

A preferred embodiment is characterized in that the acceleration sensors are each configured to detect the acceleration in 3 spatial directions. As previously mentioned, a measurement in 3 dimensions allows for particularly insightful data, wherein similar yet different, e.g. with respect to the cause, deformation patterns identify as such. This also applies to the detection of speed and/or position and/or orientation.

A preferred embodiment is characterized in that the speed sensors are each configured to detect the speed in 3 spatial directions and/or that the position sensors are configured to detect the position in 3 spatial directions.

A preferred embodiment is characterized in that the acceleration sensor of a measurement site, together with a speed sensor belonging to the same measurement site and/or a position sensor belonging to the same measurement site, is integrated in a measuring unit (installed on the structural element) and/or is accommodated in a common housing. It is preferred if the measuring unit has a flat base which carries the sensors. The flat base may be formed by a film-like and/or pliant material. Furthermore, the flat base may carry additional functional elements, such as, e.g., a wireless interface connected to the sensors for transmitting the sensor data to a (central) evaluation unit and/or an energy conversion device, preferably in miniature form, for supplying the sensors with (electrical) energy. The flat base is preferably adhered to the surface of the structural element (to be monitored) of the wind turbine.

The surface area occupied by the measuring unit amounts to 100 m² at most. The maximum thickness of the measuring unit is preferably a maximum of 5 mm The weight of the measuring unit preferably amounts to a maximum of 200 grams, particularly preferably a maximum of 100 grams.

Thanks to the space-saving and low-weight design of the measurement sites, it is ensured that the behavior of the structural element is not influenced by the sensors. The wireless communication between the sensors and a (central) evaluation device also helps save weight, which would otherwise cause an undesirable influence of the oscillation and vibration behavior of the structural element due to the cable connections.

A preferred embodiment is characterized in that the acceleration sensors and/or the speed sensors and/or the position sensors are arranged on, preferably adhered to, an outer surface of the structural element, preferably of a rotor blade. This facilitates not only the installation of the measurement sites and/or of the sensors but makes installing them later on possible in the first place. Additionally, the deformations/bending of the surface of a structural element offer particularly insightful information on the current (vibrational) state of the structural element.

A preferred embodiment is characterized in that the measurement sites and/or the sensors forming the measurement sites are energy-self-sufficient and/or are each connected to at least one local energy conversion device, which preferably converts mechanical energy, chemical energy, thermal energy and/or light into electrical energy, in particular a photovoltaic device. This saves expensive connecting cables which increase the weight, and which additionally would have to be run and fixed inside the structural element. Each measurement site is ideally locally supplied and thus self-sufficient on its own. Merely the data connection, which may also be a wireless configuration, constitutes a connection to the (central) evaluation device.

A preferred embodiment is characterized in that the acceleration sensors and/or the speed sensors and/or the position sensors are embodied as micro-electro-mechanical systems (MEMS). As previously mentioned, such sensor systems are not only reliable and durable, but also low-weight, space-saving, and easy to install. Moreover, this allows the measurement site to have very small dimensions, whereby, in turn, its position determination and the associated accuracy can be improved.

A particularly advantageous embodiment relates to a measuring arrangement for detecting deformations, in particular bending of the outer surface, of a structural element of a wind turbine, wherein the structural element is a rotor blade of the wind turbine, comprising at least three, preferably at least five, measurement sites arranged on the structural element, that are spaced from one another in the direction of the longitudinal extension of the structural element and each having at least one acceleration sensor, wherein the acceleration sensors can be communication-connected—preferably via a wireless interface—to an evaluation device, wherein the measuring arrangement has at least two speed sensors, in particular angular speed sensors, which are arranged on the structural element and spaced from one another in the direction of the longitudinal extension of the structural element, and/or at least two position sensors, in particular magnetic field sensors, which are arranged on the structural element and are spaced from one another in the direction of the longitudinal extension of the structural element, wherein the measurement sites each have at least one speed sensor and/or at least one position sensor—in addition to the acceleration sensor—, and wherein the speed sensors and/or the position sensors can be communication-connected to the evaluation device—preferably via a wireless interface, and wherein at least one, preferably at least two, of the measurement sites is/are arranged in the region of the rotor blade tip and/or at a distance from the rotor blade tip, which is at most as great as 20% of the total length of the rotor blade, and wherein at least one measurement site is arranged away from the connecting line between the outer-most measurement sites of the measuring arrangement, preferably between the measurement site closest to the rotor blade root and the measurement site closest to the rotor blade tip, wherein the normal distance from the connecting line preferably amounts to at least 20 cm, preferably at least 50 cm, and/or at least 0.5%, preferably at least 1%, of the longitudinal ex- tension of the structural element, and/or at least one measurement site is arranged on a first side, in particular the front side, of the structural element, and at least one measurement site is arranged on a second side opposite the first side, in particular on the rear side, of the structural element.

By means of these features—in particular the combination of the arrangement of one or multiple measurement sites in the vicinity of the rotor blade tip, on the one hand, and an arrangement in which at least one measurement site is not located on a connecting line between other measurement sites and/or is arranged on a different side of the structural element altogether—a particularly accurate determination of the deformations is made possible. Trials have shown that employing such a combination can significantly increase the accuracy and exploitability of the deformation data received.

A further embodiment is characterized in that the evaluation device is configured to link the acceleration data of the acceleration sensors to the speed data of the speed sensors and/or position data of the position sensors and to identify deformations of the structural element based thereon. As already mentioned above, a reliable and significantly more precise detection of the deformations of the structural element can be ensured by means of a link between the acceleration data and the speed and/or position data.

A further embodiment is characterized in that the sensors of the different measurement sites (which are spaced apart from one another) of the measuring arrangement can be synchronized in time by means of the evaluation device—preferably by means of a signal transmitted from the evaluation device to the sensors, in particular in the form of a data package—, in particular with respect to the point in time of the measurement carried out by the respective sensors and/or the point in time of the transmission of the sensor data from the sensors to the evaluation device. This can ensure—in particular in combination with a wireless transmission between the evaluation device and the sensors—that the measurements are carried out at the same time, but in any case with only a minimal time difference. Due to the high dynamics occurring in wind turbines, this measure allows a significant increase in the accuracy of the identification of the deformations and other parameters by means of the sensors. A further embodiment is characterized in that the evaluation device is configured to transmit a signal to the sensors of the measurement sites, by means of which signal the sensors of the different measurement sites (which are spaced apart from one another) are synchronized in time, so that the thusly synchronized sensors each carry out at least one measurement within a common time frame, which is preferably at most 500 μs, preferably at most 100 μs, particularly preferably at most 50 μs. Here, it is particularly preferred if the time frame in which the measurement sites belonging to different measurement sites (which are spaced apart from one another) carry out the measurement amounts to about 100 μs or less.

A further embodiment is characterized in that the evaluation device is configured to identify at least one, preferably multiple, of the following values and/or properties from the sensor data of the sensors, in particular by linking the acceleration data of the acceleration sensors to the speed data of the speed sensors and/or position data of the position sensors:
the absolute pitch angle of at least one rotor blade, and/or
the relative pitch angle of at least two rotor blades to one another, and/or
the torsion of at least one rotor blade and/or at least two rotor blades to one another, and/or
the load and/or load cycle acting o at least one rotor blade, and/or
a source for increase noise emissions, and/or
an early sign of damage or faulty regulating state of the wind turbine, and/or
the type, force, dynamics and/or direction of winds, and/or
a change of the oscillation behavior of the structural element, and/or
damage to the rotor blade,
wherein the identification of the value(s) and properties preferably comprises a comparison between current (sensor) data and historical (sensor) data and/or a comparison between the (sensor) data of a rotor blade and the (sensor) data of at least one other rotor blade.

This way, important information for the reliable and long-term operation of a wind turbine can be gathered. Additionally, the efficiency of the wind turbine can be improved, and its service life can be extended.

A further embodiment is characterized in that the evaluation device is configured to identify the deformations and/or the values and/or properties from that sensor data which was gathered by the synchronized sensors within a common time frame, which preferably amounts to a maximum of 500 μs, preferably a maximum of 100 μs, particularly preferably a maximum of 50 μs. As already mentioned, measurements of the sensors involved that are chronologically as close together as possible result in a high accuracy and great validity of the properties/parameters calculated from the sensor data.

The object is also achieved by a wind turbine comprising a rotor with at least two, preferably three, rotor blades, and at least one measuring arrangement for detecting deformations of at least one structural element, in particular of a rotor blade and/or a nacelle and/or a tower and/or a foundation, of the wind turbine, and a control device, wherein the at least one measuring arrangement is embodied according to the invention.

A preferred embodiment is characterized in that for at least two structural elements of the wind turbine, in particular for each rotor blade of the rotor, a measuring arrangement according to the invention is provided, wherein the sensors of the measuring arrangements are preferably communication-connected—preferably via a wireless interface—to a central evaluation device.

A preferred embodiment is characterized in that the control device is configured to control the wind turbine depending on the sensor signals generated by the measurement sites of the measuring arrangement, in particular to adjust the rotor with respect to the wind direction and/or to set the pitch of the rotor blades. This way, the operation state can be optimized with regard to its settings and adjustments, whereby not only the energy yield can be increased, but also the service life of the wind turbine and/or of the individual structural elements can be extended. An example is wind shear, which causes a particular deformation pattern. By recognizing such a deformation pattern, its cause can be determined, as well. The control device of the wind turbine can make settings of the wind turbine in accordance with the detected deformation patterns/causes, which settings bring the wind turbine into a deactivated state or generate and transmit an error message and/or an alarm.

The object is also achieved by a method for operating a wind turbine, which has a rotor having rotor blades and at least one measuring arrangement for detecting deformations, in particular bending of the outer surface, of a structural element of the wind turbine, in particular of a rotor blade, wherein acceleration data is gathered by means of the at least one measuring arrangement on at least one structural element, preferably in each case on all of the rotor blades of the rotor, at at least two measurement sites arranged on the structural element, which are spaced from one another in the direction of an extension, preferably the longitudinal extension, of the structural element, characterized in that speed data and/or position data is gathered at at least two sites arranged on the structural element and spaced from one another in the direction of an extension, preferably the longitudinal extension of the structural element, and that the acceleration data is linked to the speed data and/or position data in order to identify the deformation of the structural element.

As mentioned before, by linking (time-dependent) acceleration data and (time-dependent) speed data and/or position data, the detection of the deformations can be improved, particularly their accuracy can be increased. Such a link particularly makes it possible that the positions of the measurement sites can preferably be determined from the data of the sensors of the measurement sites alone. Thus, it is not necessary to know the exact position of the measurement sites beforehand. The evaluation device is configured to, e.g., determine the positions of the individual measurement sites from the acceleration data and speed data, which in most cases represent an oscillation around a neutral point and/or a reference point. The respective deviation of the measurement sites from a reference or resting position, which is determined by means of calibration before or during the operation of the wind turbine, constitutes a measure for the current degree of deformation.

A preferred embodiment is characterized in that the measuring arrangement is formed according to the invention and/or the wind turbine is formed according to the invention.

A preferred embodiment is characterized in that the speed data and/or position data is, in each case, detected at the same measurement sites at which the acceleration data is detected. In order to avoid repetitions, reference is made to the advantages stated regarding the individual embodiments of the measuring arrangement.

A preferred embodiment is characterized in that the acceleration data as well as the speed data and/or position data is gathered continuously, wherein the deformations of the structural element are preferably also identified continuously. Thereby, the dynamics of the deformation can be detected, whereby the individual deformation states can be distinguished from one another.

A preferred embodiment is characterized in that the position of the measurement site is determined based on the acceleration data detected at a measurement site and the speed data and/or position data detected at the same measurement site, wherein the determined position of the measurement site is a relative position to a reference point, in particular the rotor blade root and/or the rotor axis, and/or an absolute position. The position may be done, e.g., by integrating the acceleration data and/or speed data, wherein the additional information on a position, e.g. an orientation, also allows determining an absolute position. For example, the orientation of the measurement sites, i.e. the current angle of rotation can be determined using terrestrial magnetic field sensors as position sensors, as the magnetic field sensor registers whether a measurement site is currently moving downwards or upwards.

A preferred embodiment is characterized in that the deformation of the structural element, in particular a bending profile along an extension, preferably the longitudinal extension, of the structural element, is identified based on the determined positions of multiple measurement sites, wherein the deformation of the structural element is preferably identified in 3 dimensions.

A preferred embodiment is characterized in that the positions of the measurement sites are determined as a function of the time on the basis of the determined acceleration data as well as the speed data and/or position data, and/or that the deformations of the structural element are identified as a function of time and/or depending on the rotation angle of the rotor.

A preferred embodiment is characterized in that subject to the acceleration data as well as the speed data and/or position data, the wind turbine is controlled, in particular the rotor is adjusted with respect to the wind direction and/or the pitch of the rotor blades is set.

A preferred embodiment is characterized in that the control of the wind turbine is carried out such that the setting of the pitch of one or multiple rotor blades takes place dependent on the rotation angle of the rotor.

A preferred embodiment is characterized in that the adjustment of the settings of the wind turbine, in particular the adjustment of the orientation of the rotor and/or the adjustment of the pitch of one or multiple rotor blades in accordance with the detected acceleration data, speed data and/or position data, takes place in real time. This leads to an optimal operation if the deformation states are identified immediately, and in direct consequence—merely delayed by the latency of the sensors, the data transfer, the data processing (in the evaluation device and/or control device) and generation and implementation of the control commands—an appropriate adjustment of the settings takes place.

A preferred embodiment is characterized in that the identified accelerations, speeds and/or positions of the individual measurement sites and/or the identified deformations of the structural element, in particular the rotor blade, are compared to a (deformation) model, wherein deviations from the model are preferably used for recognizing deformation patterns. The deformation model may be, e.g., predetermined, stored (in a data base) and/or theoretically calculated models, which represent, e.g., the main deformation patterns of a structural element (that is patterns which usually occur in the operation of a wind turbine).

A preferred embodiment is characterized in that the identified deformations are compared to a number of stored deformation patterns, which may particularly comprise bending shapes and/or temporal dependencies, wherein preferably, that deformation pattern is selected which has the smallest deviations from the deformations identified. The deformation patterns may comprise any aspect of a deformation, in particular temporal and spatial dependencies, frequency and/or intensity of an oscillation or vibration, dependencies on a parameter, such as, e.g., the angle of rotation and/or the rotation speed of the rotor, a pitch setting, the wind force, etc.

A preferred embodiment is characterized in that the stored deformation patterns are each assigned at least one predetermined setting of the wind turbine, and that the setting assigned to the selected deformation pattern, in particular a certain orientation of the rotor with respect to the wind direction and/or a setting of the pitch of the rotor blades, is carried out and/or maintained. This way, the optimal settings of the wind turbine can be directly implemented—preferably in real time—for certain conditions.

A preferred embodiment is characterized in that a self-learning algorithm is stored in the control device, which algorithm is configured to adjust and/or maintain settings, in particular setting parameters, of the wind turbine based on one or multiple deformation patterns (identified by means of the sensor data), preferably based on deformation patterns identified with time lags, wherein the self-learning algorithm preferably draws on stored reference data with defor-mation patterns and/or settings. The advantages of the following embodiments have already been described in the context of the measuring arrangement and/or wind turbine and are analogously applicable to the method.

A further embodiment is characterized in that the acceleration data of the acceleration sensors are linked to the speed data of the speed sensors and/or position data of the position sensors by means of an evaluation device, which is communication-connected to the sensors, and the evaluation device identifies deformations of the structural element based thereon.

A further embodiment is characterized in that the sensors of the different measurement sites of the measuring arrangement are synchronized in time by means of the evaluation device—preferably by means of a signal transmitted from the evaluation device to the sensors, in particular in the form of a data package—, in particular with respect to the point in time of the measurement carried out by the respective sensors and/or the point in time of the transmission of the sensor data from the sensors to the evaluation device.

A further embodiment is characterized in that the evaluation device transmits a signal to the sensors of the measurement sites, by means of which signal the sensors of the different measurement sites are synchronized in time, so that the thusly synchronized sensors each carry out at least one measurement within a common time frame, which is preferably at most 500 μs, preferably at most 100 μs, particularly preferably at most 50 μs.

A further embodiment is characterized in that the evaluation device identifies at least one, preferably multiple, of the following values and/or properties from the sensor data of the sensors, in particular by linking the acceleration data of the acceleration sensors to the speed data of the speed sensors and/or position data of the position sensors:
the absolute pitch angle of at least one rotor blade, and/or
the relative pitch angle of at least two rotor blades to one another, and/or
the torsion of at least one rotor blade and/or at least two rotor blades to one another, and/or
the load and/or load cycle acting o at least one rotor blade, and/or
a source for increase noise emissions, and/or
an early sign of damage or faulty regulating state of the wind turbine, and/or
the type, force, dynamics and/or direction of winds, and/or
a change of the oscillation behavior of the structural element, and/or
damage to the rotor blade, wherein the identification of the value(s) and properties preferably comprises a comparison between current data and historical data and/or a comparison between the data of a rotor blade and the data of at least one other rotor blade.

A further embodiment is characterized in that the evaluation device identifies the deformations and/or the values and/or properties from that sensor data which was gathered by the synchronized sensors within a common time frame, which preferably amounts to a maximum of 500 μs, preferably a maximum of 100 μs, particularly preferably a maximum of 50 μs.

For the purpose of better understanding of the invention, it will be elucidated in more detail by means of the figures below.

These show in a respectively very simplified schematic representation:

FIG. 1 a wind turbine with measuring arrangements according to the invention on the rotor blades

FIG. 2 a wind turbine with measuring arrangements according to the invention on the nacelle, the tower, and the foundation

FIG. 3 a measurement site in detail

FIG. 4 an embodiment of a measurement site

FIG. 5 the evaluation of the sensor data of individual measurement sites in a schematic view

FIG. 6 three different deformation states of a rotor blade and the effective rotor blade radius along a complete revolution

FIG. 7 the determination of the deformation from acceleration data and speed data

FIG. 8 an alternative measuring arrangement on a rotor blade

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

### DESCRIPTION OF FIGURES.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

FIG. 1 and FIG. 2 show wind turbines 11, which are each equipped with measuring arrangements 10 according to the invention for detecting deformations, in particular bending of the outer surface, of a structural element. In FIG. 1, the measuring arrangements 10 formed by individual measurement sites 1 are arranged on the rotor blades 12 of the rotor 13. In FIG. 2, the measuring arrangements 10 formed by individual measurement sites 1 are arranged on the nacelle 14, on the tower 15, and on the foundation 16. A variety of combinations and extensions of the measuring arrangements shown in FIGS. 1 and 2 (as well as omissions of measuring arrangements or individual measurement sites) are of course possible. The measuring arrangement according to the invention comprises at least two measurement sites 1 arranged on the structural element 12, 14, 15, 16, the at least two measurement sites 1 being spaced apart from one another in the direction of an extension, preferably the longitudinal extension, of the structural element 12, 14, 15, 16 and each having at least one acceleration sensor 2 (see FIGS. 3 and 4). The acceleration sensors 2 are communication-connected—here, via a wireless interface 5—to an evaluation device 6, so that the sensor data can be transmitted to the evaluation device 6—preferably directly after being generated.

The evaluation device is preferably a central evaluation device, which preferably communi-cates with multiple measuring arrangements 10, each being arranged on different structural elements 12, 14, 15, 16.

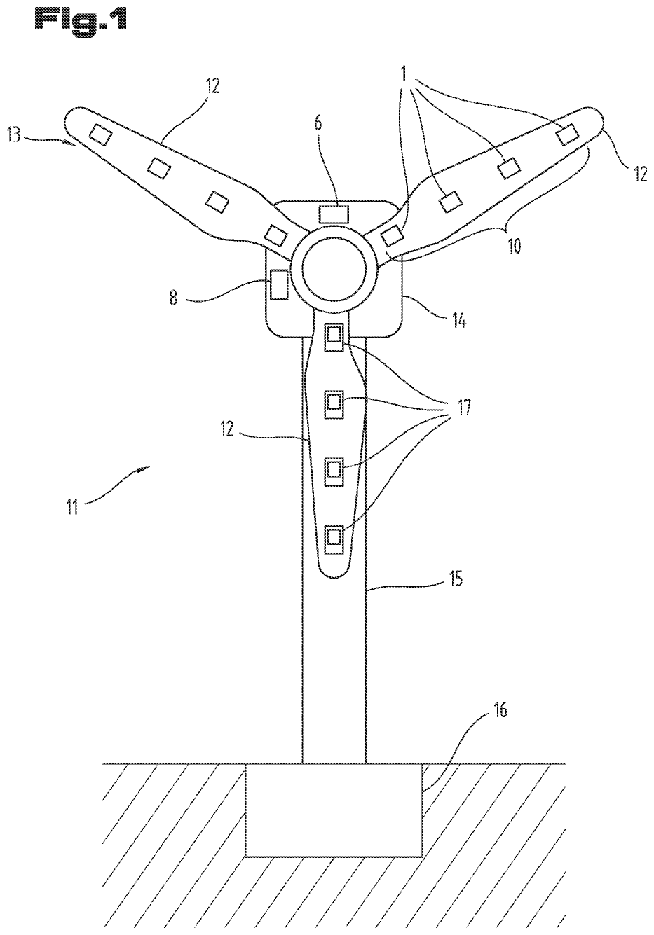

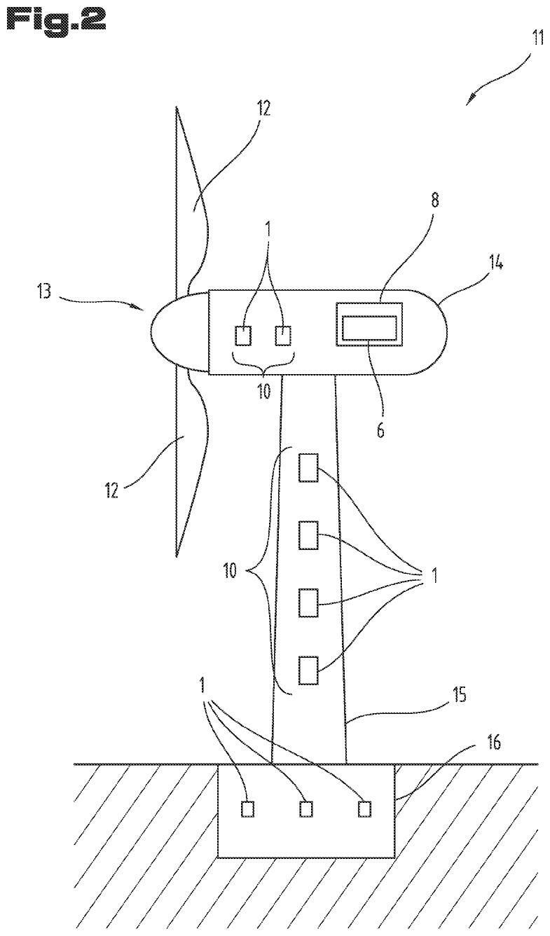

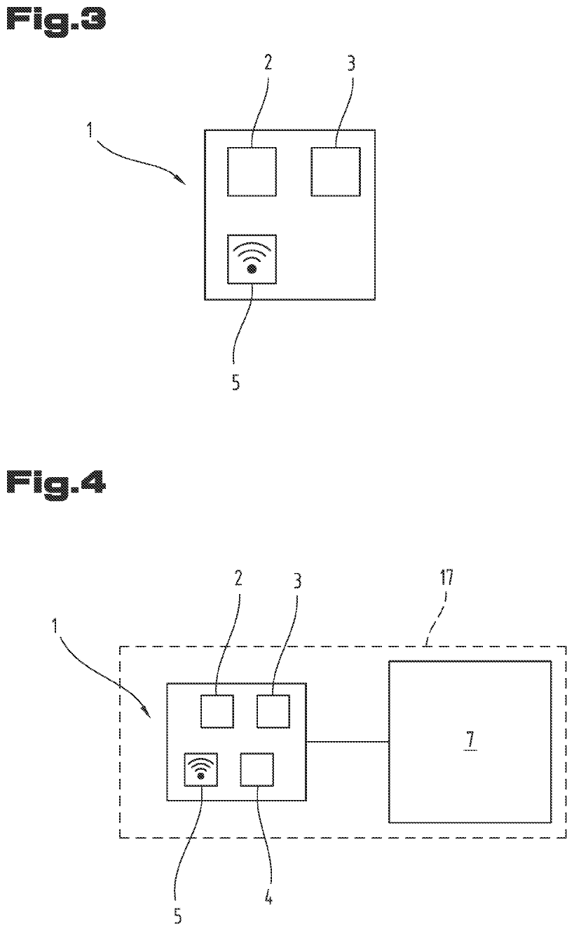

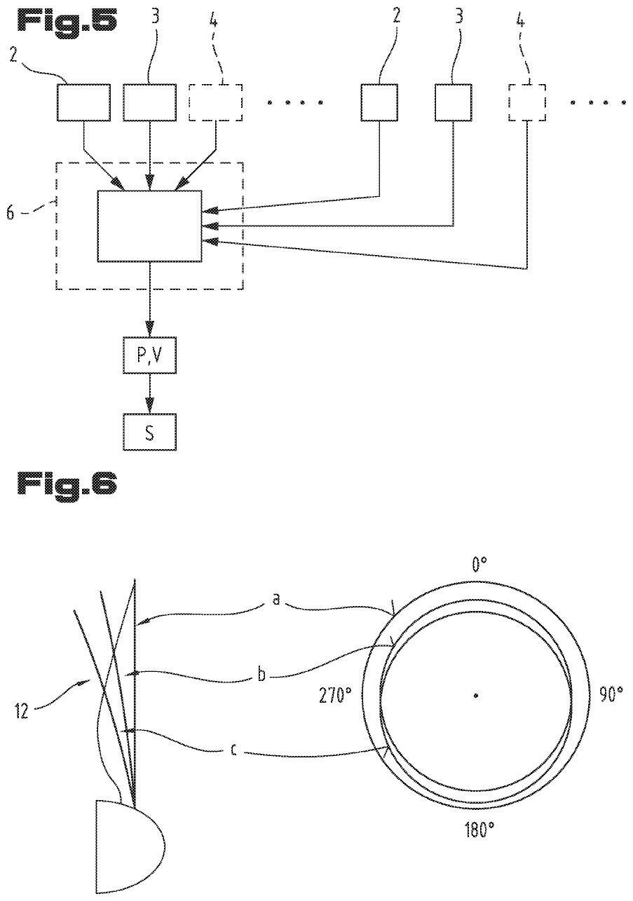

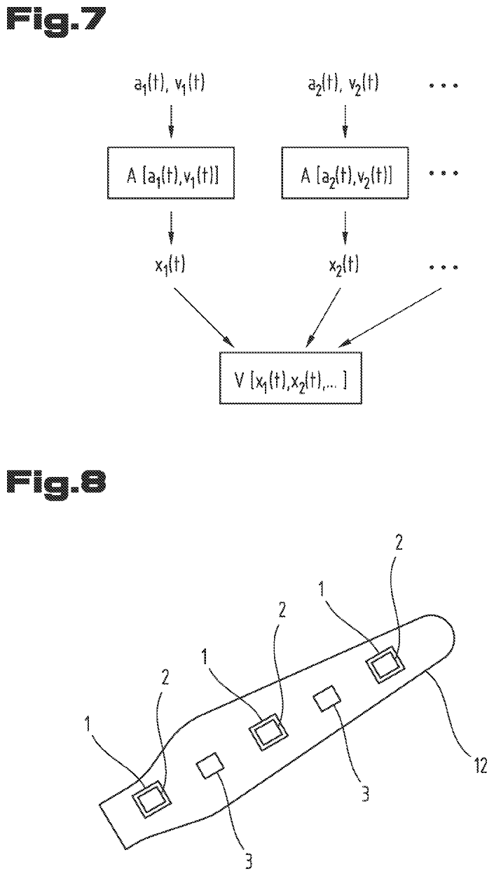

The evaluation device 6 may be integrated in the control device 8 of the wind turbine 11 (FIG. 2) or be provided as a separate device and/or module (FIG. 1).

The measuring arrangement 10 has at least two speed sensors 3, in particular angular speed sensors—in addition to the acceleration sensors 2—, which speed sensors 3 are arranged on the structural element 12, 14, 15, 16 and spaced apart from one another in the direction of an extension, preferably the longitudinal extension, of the structural element 12, 14, 15, 16.

Additionally or alternatively, the measuring arrangement 10 can have at least two position sensors 4, in particular magnetic field sensors, arranged on the structural element 12, 14, 15, 16 and spaced apart from one another in the direction of an extension, preferably the longitudinal extension, of the structural element 12, 14, 15, 16.

The speed sensors 3 and/or the position sensors 4 are also communication-connected—preferably via a wireless interface 5—to the evaluation device 6.

The speed sensors 3 may be spaced from the acceleration sensors 2 (just like the position sensors 4) (FIG. 8). However, in a preferred embodiment, the additional sensors, i.e. the speed sensors 3 and/or the position sensors 4, are in each case combined with the acceleration sensors at a measurement site 1 (FIGS. 3 and 4 in combination with FIGS. 1 and 2).

In other words: the at least two speed sensors 3 and/or the at least two position sensors 4 are arranged on the speed sensor 12, 14, 15, 16 such that the at least two measurement sites 1, each having at least one acceleration sensor 2, each additionally have at least one speed sensor 3 and/or at least one position sensor 4 (FIGS. 3 and 4).

In any case, position sensors may also be provided—instead of or in addition to the speed sensors 3 shown in FIGS. 3 and 8.

Using acceleration data (recorded directly on site) in combination with speed or position data (recorded directly on site) allows a significantly more precise detection of deformations, especially since information on acceleration, speed, and position makes it possible to resolve different timescales.

The deformation may be detected in the form of a deviation from the resting or normal state, as an elongation and/or compression, as a (spatial) change in relation to a reference point, as an oscillation (amplitude), in the form of a curvature, as a one—or multidimensional bending parameter, as a normalized representation, as a one—or multidimensional deformation pattern, as a time dependency, etc., and is thus to be interpreted broadly in its meaning.

Additionally, it is preferred if the measuring arrangement 10 comprises at least three, preferably at least five, measurement sites 1 arranged on the structural element 12, 14, 15, 16, the at least three measurement sites 1 being spaced apart from one another in the direction of the longitudinal extension of the structural element 12, 14, 15, 16, and each having at least one acceleration sensor 2. In this regard, each measurement site 1 is equipped with at least one speed sensor 3 and/or at least one position sensor 4—in addition to the acceleration sensor 2. The sensor data of all sensors are transmitted to the (central) evaluation device 6.

In this regard, the distance between an acceleration sensor 2 and a speed sensor 3 and/or position sensor 4 belonging to the same measurement site 1 are to amount to, where possible, a maximum of 5 cm, preferably a maximum of 1 cm, particularly preferably a maximum of 5 mm

In the case of a rotating rotor blade 12, at least one, preferably at least two, of the measurement sites 1 are arranged in the region of the rotor blade tip and/or at a distance from the rotor blade tip, which distance is at the most as great as 50%, preferably at most as great as 20%, of the total length of the rotor blade 12 (see FIG. 1). It is additionally preferred if at least one measurement site 1 is arranged away from the connecting line between the outermost measurement sites 1 of the measuring arrangement 10, preferably between the measurement site 1 closest to the rotor blade root and the measurement site 1 closest to the rotor blade tip. The normal distance from the connecting line preferably amounts to at least 20 cm, preferably at least 50 cm.

Likewise, at least one measurement site 1 may be arranged on a first side, in particular the front side, of the structural element 12, 14, 15, 16 and at least one measurement site 1 is arranged on a second side opposite the first side, in particular on the rear side, of the structural element 12, 14, 15, 16.

In order to be able to characterize a deformation and/or a deformation pattern more precisely, the acceleration sensors 2 are each configured to detect the acceleration in 3 spatial directions. The same also applies to the speed sensors 3 and/or the position sensors 4. For this purpose, the respective sensor 2, 3, 4 may have three (sub) units. However, a single unit configured to measure in all three spatial directions would also be conceivable.

FIG. 4 shows that the acceleration sensor 2 of a measurement site 1 together with a speed sensor 3 belonging to the same measurement site 1 and/or a position sensor 4 belonging to the same measurement site 1 may be integrated in a measuring unit 17 and/or be accommodated in a common housing.

It is preferred if the measuring unit 17 has a flat base which carries the sensors 2, 3, 4. The flat base may be formed by a film-like and/or pliant material. Furthermore, the flat base may carry additional functional elements, such as, e.g., a wireless interface 5 connected to the sensors for transmitting the sensor data to a (central) evaluation unit 6 and/or an energy conversion device 7, preferably in miniature form, for supplying the sensors 2, 3, 4 and possibly the wireless interface 5 with (electrical) energy. The flat base is preferably adhered to the surface of the structural element (to be monitored) of the wind turbine 11.

Preferably, each measurement site 1 is formed on a separate measuring unit 17.

The acceleration sensors 2 and/or the speed sensors 3 and/or the position sensors 4 may be arranged on, preferably adhered to an outer surface of the structural element 12, 14, 15, 16 (see, e.g., FIG. 1). In FIG. 4, it is adumbrated that the measurement sites 1 and/or the sensors 2, 3, 4 forming the measurement sites 1 are energy-self-sufficient and/or can each be connected to at least one local energy conversion device 7, which preferably converts mechanical energy, chemical energy, thermal energy and/or light into electrical energy, in particular a photovoltaic device.

The acceleration sensors 2 and/or the speed sensors 3 and/or the position sensors 4 are preferably embodied as micro-electro-mechanical systems (MEMS).

The wind turbine may be designed such that for at least two structural elements 12, 14, 15, 16 of the wind turbine 11, in particular for each rotor blade 12 of the rotor 13, a measuring arrangement 10 according to the invention is provided. In this regard, the sensors 2, 3, 4 of the measuring arrangement 10 are each communication-connected to the central evaluation device 6—preferably via a wireless interface 5.

The control device 8 may be configured to control the wind turbine 10 in accordance with the sensor signals generated by the measurement sites 1 of the measuring arrangement 10, in particular to adjust the rotor 13 with respect to the wind direction (e.g., rotation about a vertical or nearly vertical axis) and/or to set the pitch of the rotor blades 12.

The method for operating a wind turbine 11 having a rotor 13 with rotor blades 12 and at least one measuring arrangement 10 for detecting deformations, in particular bending of the outer surface, of a structural element 12, 14, 15, 16 of the wind turbine 11, in particular of a rotor blade 12, comprises the following steps: by means of the at least one measuring arrangement 10, acceleration data is gathered on at least one structural element 12, 14, 15, 16 (e.g. On all rotor blades 12 of the rotor 13) on at least two measurement sites 1 arranged on the structural element 12, 14, 15, 16, which measurement sites 1 are preferably spaced apart from one another in the direction of an extension, preferably the longitudinal extension, of the structural element 12, 14, 15, 16. Additionally, speed data and/or position data is gathered on at least two sites arranged on the structural element 12, 14, 15, 16 and spaced apart from one another in the direction of an extension, preferably the longitudinal extension, of the structural element 12, 14, 15, 16.

The acceleration data is linked to the speed data and/or position data for identifying the deformations of the structural element 12, 14, 15, 16. This preferably takes place by means of an algorithm. The linking and identification of the deformations preferably takes place by means of the evaluation device 6.

As already explained above, it is preferred if the speed data and/or position data is, in each case, detected at the same measurement sites 1 at which the acceleration data is detected, as well.

In the following, the principle is explained in more detail. FIG. 6 shows a rotor blade in various deformation states a, b and c as well as, to the right thereof, the effective radius along a complete rotation, i.e. depending on the rotor angle of rotation. The effective radius is obtained by a projection of the bent rotor blade—in the direction of the rotation axis of the rotor —into the rotor blade that is not bent. State a means “no deformation” (resting state), state b means “constant deformation”, and state c means asymmetrical deformation, e.g. in the case of wind shear. Such deformation patterns may be identified as follows:

FIG. 7 shows a schematic approach. Firstly, the (absolute or relative) positions x1(t), x2(t), of the individual measurement sites is determined from the acceleration data a1(t), a2(t), . . . as well as the speed data v1(t), v2(t), . . . of the individual measurement sites with the designation 1, 2, . . . by applying an algorithm A. Additionally to the acceleration and speed data (or instead of the speed data), position data (e.g. with information on the orientation) may be used in this step.

Subsequently, the deformation V (bending, torsion, oscillations, etc.) can be identified from these positions x1(t), x2(t), . . . of the individual measurement sites.

In other words, the position of the measurement site 1 is determined based on the acceleration data detected at a measurement site 1 and the speed data and/or position data detected at the same measurement site 1, wherein the determined position of the measurement site 1 may be a relative position to a reference point, in particular the rotor blade root and/or the rotor axis, and/or an absolute position.

A possibility consists in, e.g., assuming the following model, which firstly considers the static acceleration As, which is essentially a function of the gravitational acceleration ag and the centrifugal acceleration a_{c}.

$${A}_{s} = {R}_{x} \cdot {R}_{z} \cdot ( {R}_{y} \cdot ( \begin{matrix}{a}_{g} \\ 0 \\ 0\end{matrix} ) + ( \begin{matrix}- {a}_{c} \\ 0 \\ 0\end{matrix} ) )$$

Rₓ is the rotation matrix of a measurement site about the x-axis due to the pitch. R_{z} is the rotation matrix of the measurement site about the z-axis due to the orientation of the rotor and/or the measurement site. R_{y} is the rotation matrix of the measurement site about the y-axis, which corresponds to the rotation of the rotor 13 about its rotations axis.

Furthermore, dynamic accelerations A_{d}, such as Coriolis acceleration and the Euler acceleration, which are dependent on, inter alia, the rotation speed and the position of the respective measurement site, may be included in the model: A=Aₛ+A_{d}.

From the above model, it is evident that particularly the speeds, possibly, however, also the positions and/or orientations of the measurement site, in particular in the form of the rotation matrixes, have a significant importance in the modelling of the acceleration and/or the deformation to be detected. By means of the concept according to the invention of measuring the speeds and/or positions directly on site—i.e. directly on the structural element itself that is moving, oscillating, or subjected to any other deformations, preferably in each case on a measurement site, the accuracy of the deformation detection can be increased significantly. A reason for this is that the treatment of a measurement site—e.g., by means of a model or algorithm—can be carried out individually and based on the data recorded directly at the measurement site (acceleration data as well as speed and/or position data).

The acceleration data as well as the speed data and/or position data can be detected continuously, wherein the deformations of the structural element 12, 14, 15, 16 are preferably also identified continuously.

From the determined positions of multiple measurement sites 1, the deformation of the structural element, in particular a bending profile along an extension, preferably the longitudinal extension of the structural element, can be determined. This preferably takes place in 3 dimensions. The values schematically shown in FIG. 17 are, in this case, vectors and/or matrixes. Based on the identified acceleration data as well as the speed data and/or position data, the positions of the measurement sites 1 can also be determined as a function of time. It is also possible to identify the deformations of the structural element 12, 14, 15, 16 as a function of time and/or depending on the rotation angle of the rotor 13.

In FIG. 5, it is additionally adumbrated that, subject to the acceleration data as well as the speed data and/or position data, the wind turbine 11 can be controlled, in particular the rotor 13 can be adjusted with respect to the wind direction and/or the pitch of the rotor blades 12 is set. In this regard, control commands S can be generated as a function of the determined positions (of the measurement sites) and deformations V of the structural element, which control commands S are forwarded from the evaluation device 6 and/or control device 8 to appropriate actuators of the wind turbine 11.

FIG. 6 shows that in state c, an asymmetrical deformation (i.e. one that depends on the angle of rotation) occurs. In such cases, the control of the wind turbine 11 can then be carried out such that the setting of the pitch of one or multiple rotor blades 12 takes place depending on the rotor blade of the rotor 13 in order to handle such an asymmetrical deformation in the best possible way. Depending on the rotation angle means that different settings can be made within one revolution of the rotor (at least two, preferably any number).

The advantages of a setting in real time have already been extensively explained above.

Moreover, the identified accelerations, speeds and/or positions of the individual measurement sites 1 and/or the identified deformations of the structural element 12, 14, 15, 16, in particular the rotor blade 12, can be compared to a model, wherein deviations from the model are preferably used for recognizing deformation patterns.

The identified deformations may also be compared to a number of stored deformation patterns, which may particularly comprise bending shapes and/or temporal dependencies. In this regard, that deformation pattern can be selected which has the least deviations from the deformations identified.

The stored deformation patterns may each be assigned at least one predefined setting of the wind turbine 11. The setting, in particular a certain orientation of the rotor 13 with respect to the wind direction and/or a setting of the pitch of the rotor blades 12, assigned to the selected deformation pattern is then carried out and/or maintained.

Lastly, a self-learning algorithm may be stored in the control device 8, which algorithm is configured to adjust and/or maintain settings, in particular setting parameters, of the wind turbine 11 based on one or multiple deformation patterns, preferably based on deformation patterns identified with time lags, wherein the self-learning algorithm preferably draws on stored reference data with deformation patterns and/or settings.

The following variants relate to the preferred possibility of bringing the sensors belonging to different measurement sites spaced apart from one another into a temporal common mode. Thus, the sensors 2, 3, 4 of the different measurement sites 1 can be synchronized in time by means of the evaluation device 6—preferably by means of a signal transmitted from the evaluation device 6 to the sensors 2, 3, 4, in particular in the form of a data package—, in particular with respect to the point in time of the measurement carried out by the respective sensors 2, 3, 4 and/or the point in time of the transmission of the sensor data from the sensors 2, 3, 4 to the evaluation device 6.

Here, it is preferred if the evaluation device 6 is configured to transmit a signal to the sensors 2, 3, 4 of the measurement sites 1, by means of which signal the sensors 2, 3, 4 of the different measurement sites 1 are synchronized in time, so that the thusly synchronized sensors 2, 3, 4 each carry out at least one measurement within a common time frame, which is preferably at most 500 μs, preferably at most 100 μs, particularly preferably at most 50 μs.

In other words: The sensors are brought into common mode via data packages transmitted from the base such that they measure simultaneously within a tolerance of preferably <100 μs, in an advantageous embodiment <50 μs or below. Thus, the approximately same, simultaneous sampling at multiple positions is possible—even if the transmission between base/evaluation device is wireless and the sensors depend on one another (i.e. in the case of sensors which do not or at least do not necessarily communicate with one another).

Additionally and alternatively to the deformations, at least one, preferably multiple, of the following values and/or properties can be identified from the sensor data of the sensors 2, 3, 4, in particular by linking the acceleration data of the acceleration sensors 2 to the speed data of the speed sensors 3 and/or position data of the position sensors 4:
the absolute pitch angle of at least one rotor blade, and/or
the relative pitch angle of at least two rotor blades to one another, and/or
the torsion of at least one rotor blade and/or at least two rotor blades to one another, and/or
the load and/or load cycle acting o at least one rotor blade, and/or
a source for increase noise emissions, and/or
an early sign of damage or faulty regulating state of the wind turbine, and/or
the type, force, dynamics and/or direction of winds, and/or
a change of the oscillation behavior of the structural element, and/or
damage to the rotor blade,
wherein the identification of the value(s) and properties preferably comprises a comparison between current (sensor) data and historical (sensor) data and/or a comparison between the (sensor) data of a rotor blade and the (sensor) data of at least one other rotor blade.

The measurement of the torsion of the blades may take place statically, dynamically and/or with respect to the individual rotor blades relative to one another. Thus, blade loads and load cycles may also be determined. Measuring vibration patterns may also take place locally, globally and/or with respect to the individual rotor blades relative to one another. Based on this, e.g. a source for increased noise emissions or an early sign of damage or faulty regulating state can be identified. Moreover, the detection/characterization of wind shears, turbulences, gusts of wind, oblique incoming flow and/or incorrect azimuth angles of the wind turbine is possible. Rotor damage may be recognized, e.g. based on an altered oscillation behavior of the rotor blade (e.g. by comparing a sensor position to historical data at the same position or comparing a radial position to current data gathered from other rotor blades).

Here, as well the evaluation device 6 is preferably configured to identify the deformations and/or the values and/or properties from that sensor data which was gathered by the sensors 2, 3, 4 within a common time frame, which preferably amounts to a maximum of 500 μs, preferably a maximum of 100 μs, particularly preferably a maximum of 50 μs.

List of reference numbers
1 Measuring site
2 Acceleration sensor
3 Speed sensor
4 Position sensor
5 Wireless interface
6 Evaluation device
7 Photovoltaic device
8 Controller
9 —
10 Measuring arrangement
11 Wind turbine
12 Rotor blade
13 Rotor
14 Nacelle
15 Tower
16 Foundation
17 Measuring unit
a No bend
b Constant bend
c Bend in wind shear
P Position
S Control command
A Algorithm
a₁(t), a₂(t) Acceleration data
v₁(t), v₂(t) Speed data
x₁(t), x₂(t) Position data
V Deformation

40-40 (canceled).

41. A measuring arrangement (10) for detecting deformations, in particular bending of the outer surface, of a structural element (12, 14, 15, 16) of a wind turbine (11), wherein the structural element is a rotor blade (12) of the wind turbine (11), comprising:
at least three, preferably at least five, measurement sites (1) arranged on the structural element (12, 14, 15, 16), the at least two measurement sites (1) being spaced apart from one another in the direction of the longitudinal extension, of the structural element (12) and each having at least one acceleration sensor (2),
wherein the acceleration sensors (2) can be communication-connected—preferably via a wireless interface (5)—to an evaluation device (6),
wherein the measuring arrangement (10) has at least two speed sensors (3), in particular angular speed sensors, arranged on the structural element (12) and spaced apart from one another in the direction of longitudinal extension, of the structural element (12),
and/or wherein the measuring arrangement (10) has at least two position sensors (4), in particular magnetic field sensors, arranged on the structural element (12) and spaced apart from one another in the direction of the longitudinal extension, of the structural element (12, 14, 15, 16)
wherein the measurement sites (1) each have at least one speed sensor (3) and/or at least one position sensor (4)—in addition to the acceleration sensor (2)—, and,
wherein the speed sensors (3) and/or the position sensors (4) can be communication-connected to the evaluation device (6)—preferably via a wireless interface (5),
and wherein at least one, preferably at least two, of the measurement sites (1) is/are arranged in the region of the rotor blade tip and/or at a distance from the rotor blade tip, which distance is at the most as great as 20% of the total length of the rotor blade (12),
and wherein
at least one measurement site (1) is arranged away from the connecting line between the outermost measurement sites (1) of the measuring arrangement (10), preferably between the measurement site (1) closest to the rotor blade root and the measurement site (1) closest to the rotor blade tip, wherein preferably the normal distance from the connecting line amounts to at least 20 cm, preferably at least 50 cm, and/or at least 0.5%, preferably at least 1%, of the longitudinal extension of the structural element (12),
and/or wherein at least one measurement site (1) is arranged on a first side, in particular the front side, of the structural element (12), and at least one measurement site (1) is arranged on a second side opposite the first side, in particular on the rear side, of the structural element (12).

42. The measuring arrangement according to claim 41, wherein the distance between an acceleration sensor (2) and a speed sensor (3) and/or position sensor (4) belonging to the same measurement site (1) amounts to a maximum of 5 cm, preferably a maximum of 1 cm, particularly preferably a maximum of 5 mm, and/or wherein the acceleration sensor (2) of a measurement site (1), together with a speed sensor (3) belonging to the same measurement site (1) and/or a position sensor (4) belonging to the same measurement site (1), is integrated in a measuring unit (17) and/or is accommodated in a common housing.

43. The measuring arrangement according to claim 41, wherein the acceleration sensors (2) are each configured to detect the acceleration in 3 spatial directions, and/or wherein the speed sensors (3) are each configured to detect the speed in 3 spatial directions, and/or wherein the position sensors (4) are configured to detect the position or orientation in 3 spatial directions.

44. The measuring arrangement according to claim 41, wherein the measuring unit (17) has a flat base which carries the sensors (2, 3, 4), wherein the flat base is preferably formed by a film-like and/or pliant material and preferably carries at least one additional functional element, in particular a wireless interface (5) connected to the sensors (2, 3, 4) for transmitting the sensor data to an evaluation unit (6) and/or an energy conversion device (7) for supplying the sensors (2, 3, 4) with energy, wherein the flat base is preferably adhered to the surface of the rotor blade (12) of the wind turbine (11).

45. The measuring arrangement according to claim 41, wherein the acceleration sensors (2) and/or the speed sensors (3) and/or the position sensors (4) are arranged on, preferably adhered to, an outer surface of the rotor blade (12).

46. The measuring arrangement according to claim 41, wherein the acceleration sensors (2) and/or the speed sensors (3) and/or the position sensors (4) are embodied as micro-electro-mechanical systems (MEMS).

47. The measuring arrangement according to claim 41, wherein the evaluation device (6) is configured to link the acceleration data of the acceleration sensors (2) to the speed data of the speed sensors (3) and/or position data of the position sensors (4) and to identify deformations of the structural element (12) based thereon.

48. The measuring arrangement according to claim 41, wherein the sensors (2, 3, 4) of the different measurement sites (1) of the measuring arrangement (10) may be synchronized in time by means of the evaluation device (6)—preferably by means of a signal transmitted from the evaluation device (6) to the sensors (2, 3, 4), in particular in the form of a data package—, in particular with respect to the point in time of the measurement carried out by the respective sensors (2, 3, 4) and/or the point in time of the transmission of the sensor data from the sensors (2, 3, 4) to the evaluation device (6).

49. The measuring arrangement according to claim 41, wherein the evaluation device (6) is configured to transmit a signal to the sensors (2, 3, 4) of the measurement sites (1), by means of which signal the sensors (2, 3, 4) of the different measurement sites (1) are synchronized in time, so that the thusly synchronized sensors (2, 3, 4) each carry out at least one measurement within a common time frame, which is preferably at most 500 μs, preferably at most 100 μs, particularly preferably at most 50 μs.

50. The measuring arrangement according to claim 41, wherein the evaluation device is configured to identify at least one, preferably multiple, of the following values and/or properties from the sensor data of the sensors (2, 3, 4), in particular by linking the acceleration data of the acceleration sensors (2) to the speed data of the speed sensors (3) and/or position data of the position sensors (4):
the absolute pitch angle of at least one rotor blade, and/or
the relative pitch angle of at least two rotor blades to one another, and/or
the torsion of at least one rotor blade and/or at least two rotor blades to one another, and/or
the load and/or load cycle acting o at least one rotor blade, and/or
a source for increase noise emissions, and/or
an early sign of damage or faulty regulating state of the wind turbine, and/or
the type, force, dynamics and/or direction of winds, and/or
a change of the oscillation behavior of the structural element, and/or
damage to the rotor blade,
wherein the identification of the value(s) and properties preferably comprises a comparison between current data and historical data and/or a comparison between the data of a rotor blade and the data of at least one other rotor blade.

51. The measuring arrangement according to claim 41, wherein the evaluation device (6) is configured to identify the deformations and/or the values and/or properties from that sensor data which was gathered by the synchronized sensors (2, 3, 4) within a common time frame, which preferably amounts to a maximum of 500 μs, preferably a maximum of 100 μs, particularly preferably a maximum of 50 μs.

52. A wind turbine (11) comprising:
a rotor (13) having at least two, preferably three, rotor blades (12), and at least one measuring arrangement (10) for detecting deformations of at least one structural element of the wind turbine (11), wherein the structural element is a rotor blade (12) of the wind turbine (11), and
a control device (8),
wherein the at least one measuring arrangement (10) is formed according to claim 41.

53. The wind turbine according to claim 52, wherein for at least two rotor blades (12) of the wind turbine (11), in particular for each rotor blade (12) of the rotor (13), a measuring arrangement (10) is provided, wherein the sensors (2, 3, 4) of the measuring arrangements (10) are preferably communication-connected—preferably via a wireless interface (5)—to a central evaluation device (6).

54. The wind turbine according to claim 52, wherein the control device (8) is configured to control the wind turbine (10) depending on the sensor signals generated by the measurement sites (1) of the measuring arrangement (10), in particular to adjust the rotor (13) with respect to the wind direction and/or to set the pitch of the rotor blades (12).

55. A method for operating a wind turbine (11), which has a rotor (13) having rotor blades (12) and at least one measuring arrangement (10) for detecting deformations, in particular bending of the outer surface, of a structural element of the wind turbine (11), which structural element is a rotor blade (12), wherein acceleration data is gathered by means of the at least one measuring arrangement (10) on at least one rotor blade (12), preferably in each case on all of the rotor blades (12) of the rotor (13), at least two measurement sites (1) arranged on the rotor blade (12), the at least two measurement sites (1) being spaced apart from one another in the direction of an extension, preferably the longitudinal extension, of the rotor blade (12), wherein speed data and/or position data is gathered at least two sites arranged on the structural element (12, 14, 15, 16) and spaced apart from one another in the direction of an extension, preferably the longitudinal extension, of the structural element (12, 14, 15, 16),
and wherein the acceleration data is linked to the speed data and/or position data for identifying the deformations of the rotor blade (12)—preferably by means of an evaluation device (6) communication-connected to the sensors (2, 3, 4), and wherein the measuring arrangement (10) is formed according to claim 41.

56. The method according to claim 55, wherein the speed data and/or position data is, in each case, detected at the same measurement sites (1) at which the acceleration data is detected.

57. The method according to claim 55, wherein the position of the measurement site (1) is determined based on the acceleration data detected at a measurement site (1) and the speed data and/or position data detected at the same measurement site (1), wherein the determined position of the measurement site (1) is a relative position to a reference point, in particular the rotor blade root and/or the rotor axis, and/or an absolute position.

58. The method according to claim 55, wherein the deformation of the structural element (12), in particular a bending profile along an extension, preferably the longitudinal extension, of the structural element (12), is identified based on the determined positions of multiple measurement sites (1), wherein the deformation of the structural element (12) is preferably identified in 3 dimensions.

59. The method according to claim 55, wherein the positions of the measurement sites (1) are determined as a function of the time on the basis of the identified acceleration data as well as the speed data and/or position data, and/or wherein the deformations of the structural element (12) are identified as a function of time and/or depending on the rotation angle of the rotor (13).

60. The method according to claim 55, wherein, subject to the acceleration data as well as the speed data and/or position data, the wind turbine (11) is controlled, in particular the rotor (13) is adjusted with respect to the wind direction and/or the pitch of the rotor blades (12) is set.

61. The method according to claim 55, wherein the control of the wind turbine (11) is carried out such that the setting of the pitch of one or multiple rotor blades (12) takes place dependent on the rotation angle of the rotor (13).

62. The method according to claim 55, wherein the identified deformations are compared to a number of stored deformation patterns, which may particularly comprise bending shapes and/or temporal dependencies, wherein preferably, that deformation pattern is selected which has the smallest deviations from the deformations identified.

63. The method according to claim 55, wherein the evaluation device (6) transmits a signal to the sensors (2, 3, 4) of the measurement sites (1), by means of which signal the sensors (2, 3, 4) of the different measurement sites (1) are synchronized in time, so that the thusly synchronized sensors (2, 3, 4) each carry out at least one measurement within a common time frame, which is preferably at most 500 μs, preferably at most 100 μs, particularly preferably at most 50 μs, and/or wherein the evaluation device (6) identifies the deformations and/or the values and/or properties from that sensor data which was gathered by the synchronized sensors (2, 3, 4) within a common time frame, which preferably amounts to a maximum of 500 μs, preferably a maximum of 100 μs, particularly preferably a maximum of 50 μs.
